(19) United States
(12) Patent Application Publication
(10) Pub. No.: US 2010/0100389 A1
(43) Pub. Date: Apr. 22, 2010

(54) System for Signal Sample Rate Conversion

(75) Inventor: Jay Randall Stoner, Redding, CA (US)

Correspondence Address: HENNEMAN & ASSOCIATES, PLC, 70 N. MAIN ST., THREE RIVERS, MI, 49093, US

(73) Assignee: VNS PORTFOLIO LLC, Cupertino, CA (US)

(21) Appl. No.: 12/256,249

(22) Filed: Oct. 22, 2008

(51) Int. Cl. G10L 21/00

(52) U.S. Cl. 704/500; 700/94

(57) ABSTRACT

An apparatus and method for converting a source signal at a first rate to a re-sampled signal at a second rate using an array of processors. A decoder decomposes the source signal into left and right source values and sends an aperture signal to a coefficient control unit upon decomposition completion. A transfer unit controllably receives and passes the left and right source values on to a re-sampler. The coefficient control unit calculates a polyphase offset based on the aperture signal and a clock signal. A coefficient server selectively passes coefficients to the re-sampler based on the polyphase offset. And the re-sampler generates the re-sampled signal based on the left and right source values and the coefficients.

### BACKGROUND OF THE INVENTION

1. Technical Field

The present invention relates generally to coded data generation or conversion, and more particularly to such for changing the number of bits per unit of time during which the bits comprising a digital signal are presented.

2. Background Art

Sample rate conversion is the process of converting a signal (usually in digital form) from one sampling rate to another, while changing the information represented by the signal as little as possible. Such conversion is often needed today because different electronic systems often use different sampling rates, for engineering, economic, or historical reasons. For example, American television, European television, and movies all use different numbers of frames per second. And as another example, audio systems currently use different rates of 32, 44.1, 48, and 96 kHz.

The modern home theater system (HTS) serves as a more detailed example. A HTS allows its users to enjoy audio-video entertainment, such as watching a movie from a DVD or listening to music from a CD, as two examples. A HTS will typically include a video processing sub-system, an audio decoding sub-system (that is either as a standalone sub-system or as part of the video processing sub-system), a video playback unit (e.g., a display), and audio playback units (e.g., speakers or headphones).

Of particular present interest is the work that a HTS must perform to replay audio content. Audio CDs have two channels of 16-bit pulse code modulation (PCM) encoded data at a 44.1 kHz sampling rate. In contrast, the audio track of a DVD typically has up to 6 channels of data available which are similarly encoded but at a 48 KHz sampling rate. The HTS thus has to convert from the encoded sampling rate in the various media types to a common sampling rate for use with audio playback equipment and this is a complex task.

Prior art approaches to sample rate conversion have generally fallen into two classes. A general processor can be programmed for the task or specialized hardware can be built for the task. Using a general processor for sample rate conversion is usually a severe resource miss allocation. For example, most personal computers (PCs) can perform sample rate conversion (e.g., for Audio Codec '97). But a PC will almost always be grossly underutilized if dedicated to this (idling through clock cycles between tasks), and heavily burdened when actually doing rate conversion. In contrast, specialized hardware can provide a very close resource allocation. But this approach suffers from a parade of horrible, including for instance, finding skilled developers, long development times, long debugging stages (and reduced confidence in this having been adequate), complexity in all regards, and notoriously high costs.

Accordingly, it generally follows that advances in systems and techniques for rate conversion to a true common sample rate are still needed and will be well received.

### BRIEF SUMMARY OF THE INVENTION

Accordingly, it is an object of the present invention to provide apparatus and methods for signal sample rate conversion.

Briefly, one preferred embodiment of the present invention is an apparatus for converting a source signal at a first sampling rate to a re-sampled signal at a second sampling rate. An array of processors is provided in which a decoder is implemented from a plurality of the processors, a transfer unit is implemented from at least one processor, a coefficient control unit is implemented from a plurality of the processors, a coefficient server is implemented from at least one processor, and a re-sampler is implemented from a plurality of the processors. The decoder decomposes the source signal into left and right source values and sends an aperture signal to the coefficient control unit upon decomposition completion. The transfer unit controllably receives and passes the left and right source values on to the re-sampler. The coefficient control unit calculates a polyphase offset based on the aperture signal and a clock signal. The coefficient server selectively passes coefficients to the re-sampler based on the polyphase offset. And the re-sampler generates the re-sampled signal based on the left and right source values and the coefficients.

Briefly, another preferred embodiment of the present invention is a method for converting a source signal at a first sampling rate to a re-sampled signal at a second sampling rate with an array of processors. The source signal is decomposed in a plurality of the processors into left and right source values and an aperture signal is provided upon completion of this decomposing. A polyphase offset is calculated in a plurality of the processors based on the aperture signal and a clock signal. Coefficients are provided based on the polyphase offset. And the re-sampled signal is generated in a plurality of the processors based on the left and right source values and the coefficients.

These and other objects and advantages of the present invention will become clear to those skilled in the art in view of the description of the best presently known mode of carrying out the invention and the industrial applicability of the preferred embodiment as described herein and as illustrated in the figures of the drawings.

### BRIEF DESCRIPTION OF THE SEVERAL VIEWS OF THE DRAWING(S)

The purposes and advantages of the present invention will be apparent from the following detailed description in conjunction with the appended figures of drawings in which:

FIG. 1 (prior art) is a diagrammatic view of an array of computers, cores, or nodes that may be used with the present invention.

FIG. 2 (prior art) is a diagrammatic view of the major internal features of one of the nodes in FIG. 1.

FIG. 3 (prior art) is a table of the thirty two operational codes (op-codes) in VentureForth® programming language, in hex, mnemonic, and binary representations.

FIG. 4 is a diagrammatic view of a rate conversion device in accord with the present invention.

FIG. 5 is a table showing the mappings of all of the expected raw sigma counts against the phase angle offsets, as well as where the phase angle offsets are stored.

FIG. 6 is a flow chart showing a process in which a non-linear function with the raw sigma count as an argument is used to look up stored phase angle offsets.

FIG. 7 is a flow chart showing a process in which a new polyphase offset is obtained.

FIG. 8 is a flow chart showing a process in which a set of coefficients for a given polyphase offset is obtained.

In the various figures of the drawings, like references are used to denote like or similar elements or steps.

### DETAILED DESCRIPTION OF THE INVENTION

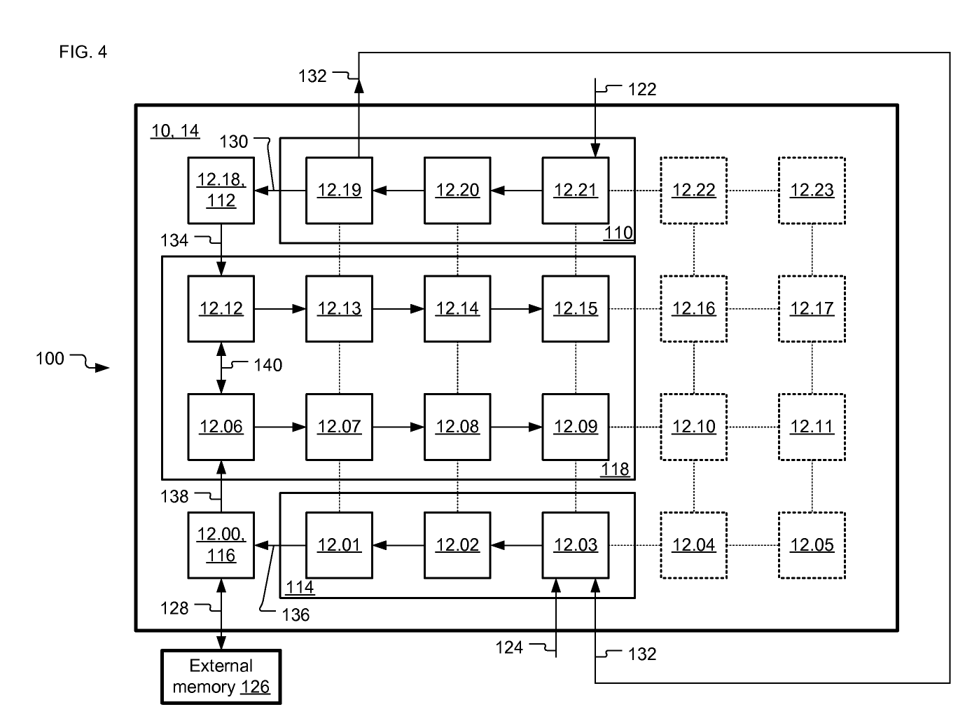

A preferred embodiment of the present invention is a system for signal sample rate conversion based on performing a polyphase finite impulse response (FIR) filter in a control structure on an array of processors. As illustrated in the various drawings herein, and particularly in the view of FIG. 4, preferred embodiments of the invention are depicted by the general reference character 100.

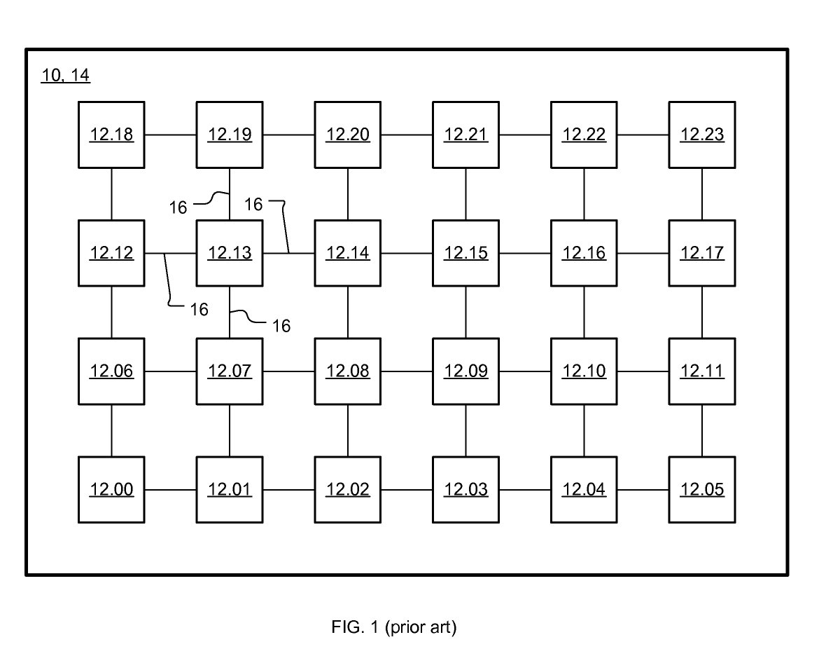

FIG. 1 (prior art) is a diagrammatic view of an array 10 (twenty-four are shown) of computers, cores, or nodes that may be used with the present invention. The array 10 here may particularly be a SEAforth® 24a device by IntellaSys® Corporation of Cupertino, Calif., a member of The TPL Group of companies, and for the sake of example the following discussion proceeds on this basis. When discussing the microprocessors in the a SEAforth® 24a device, the term “nodes” is usually used and in the following discussion these are referred to collectively as nodes 12 and individually as nodes 12.00-12.23. The array 10 of nodes 12 in a SEAforth® 24a device is implemented in a single semiconductor die 14, wherein each of the nodes 12 is a generally independently functioning digital processor that is interconnected to its adjacent nodes by a plurality of interconnecting data buses 16.

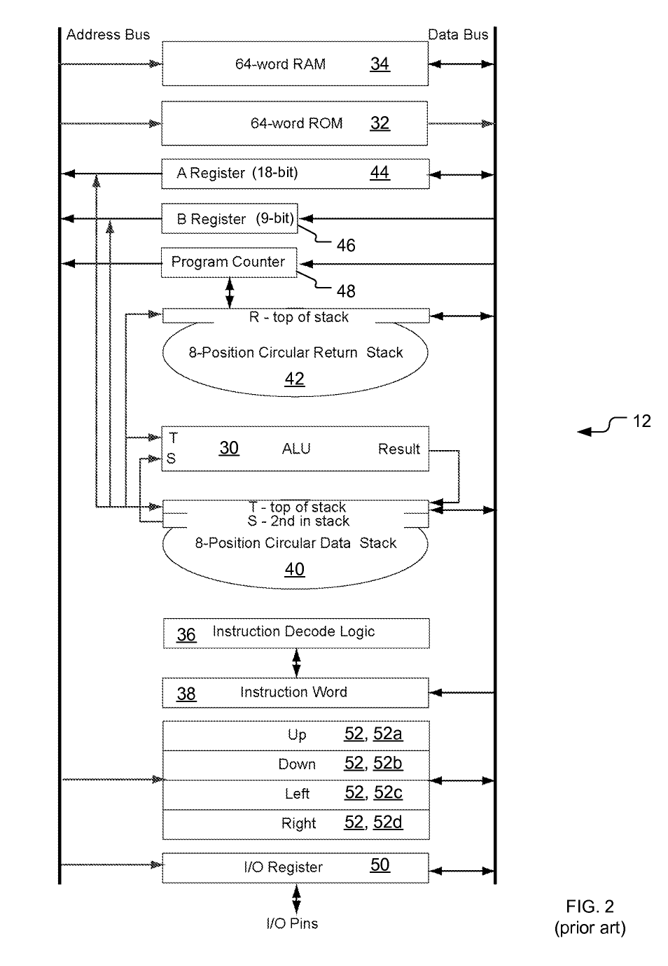

FIG. 2 (prior art) is a diagrammatic view of the major internal features of one of the nodes 12 in FIG. 1, that is, of each of the nodes 12.00-12.23. As can be seen, each node 12 is generally an independently functioning digital processor, including an arithmetic logic unit (ALU 30), a quantity of read only memory (ROM 32), a quantity of random access memory (RAM 34), an instruction decode logic section 36, an instruction word 38, a data stack 40, and a return stack 42. Also included are an 18-bit “A” register (A-register 44), a 9-bit “B” register (B-register 46), a 9-bit program counter register (P-register 48), and an 18-bit I/O control and status register (IOCS-register 50). Further included are four communications ports (collectively referred to as ports 52 and individually as ports 52a-d). Except for the edge and corner cases, these ports 52 each connect to a respective data bus 16 (FIG. 1), wherein each data bus 16 has 18 data lines, a read line, and a write line (not shown individually in FIGS. 1-2).

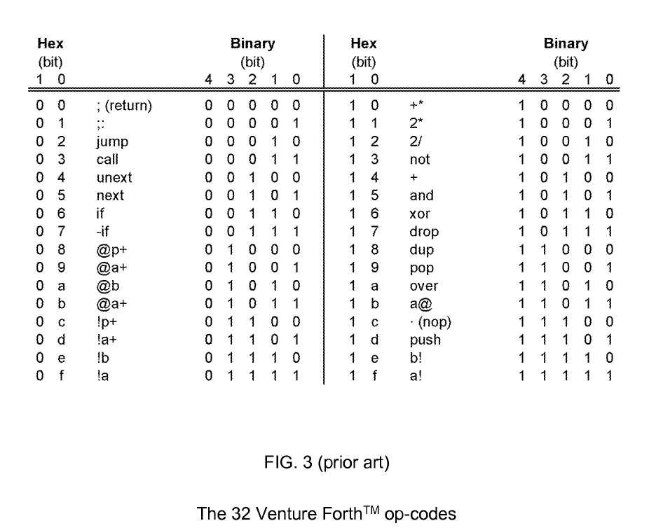

As general background, the SEAforth® 24a has 24 stack-based microprocessor cores or nodes that all use the VentureForth® programming language. FIG. 3 (prior art) is a table of the thirty two operational codes (op-codes) in this language, in hex, mnemonic, and binary representations. These op-codes are divided into two main categories, memory instructions and arithmetic logic unit (ALU) instructions, with sixteen op-codes in each division. The memory instructions are shown in the left half of the table in FIG. 3 and the ALU instructions are shown in the right half of the table in FIG. 3. It can be appreciated that one clear distinction between the divisions of op-codes is that the memory instructions contain a zero (0) in the left-most bit, whereas the ALU instructions contain a one (1) in the left-most bit. Furthermore, this is the case regardless of whether the op-codes are viewed in their hex or binary representations.

FIG. 4 is a diagrammatic view of a rate conversion device 100 in accord with the present invention. As now described, this embodiment of the rate conversion device 100 converts from an incoming 32, 44.1, or 48 kHz signal to a common 48 kHz signal. The rate conversion device 100 includes five major units that each comprise at least one node 12 in an array 10 of processors. These major units are a decoder 110, a L/R transfer unit 112, a coefficient control unit 114, a memory/coefficient server 116, and a re-sampler 118. In the embodiment shown, the decoder 110 is made up of nodes 12.19, 12.20, and 12.21; the L/R transfer unit 112 is made up of only node 12.18; the coefficient control unit 114 is made up of nodes 12.01, 12.02, and 12.03; the memory/coefficient server 116 is made up of only node 12.00; and the re-sampler 118 is made up of nodes 12.06, 12.07, 12.08, 12.09, 12.12, 12.13, 12.14, and 12.15.

In addition, the rate conversion device 100 works with three major external elements, including an audio signal source (not shown) that provides an audio signal on a line 122, a reference clock (not shown) that provides a clock signal on a line 124, and an external memory 126 that communicates with the rate conversion device 100 via a line 128. The audio signal source, for instance, may be a S/PDIF cable that provides a left (L) 16-bit PCM audio channel value and a right (R) 16-bit PCM audio channel value on line 122. The clock signal on line 124 is one sufficiently fast to accurately measure the phase angle of each decomposed sample pair (2.688 MHz is used here). And the external memory 126 can be any suitable for the storage needs of the application, and potentially can instead be an internal memory if other hardware than the SEAforth® 24a is used.

### The Decoder

The role of the decoder 110 is to decompose each pair of L/R audio channel PCM values received via line 122 and provide these as two 18-bit PCM values on a line 130 to node 12.18 in the L/R transfer unit 112. In actuality, the decoder 110 here produces two 16-bit values, but the registers and the data busses used to transfer the data in the SEAforth® 24a device are 18-bits wide. Coincidental with the completion of the decomposition of each L/R pair, an aperture signal is also sent via a line 132 to node 12.03 in the coefficient control unit 114. In actuality here in this embodiment, this aperture signal is bit-17 of the IOCS-register 50 of node 12.19.

### The L/R Transfer Unit

The L/R transfer unit 112 is made up of only node 12.18, and its role is simply to pass the two values it receives on to node 12.12 of the re-sampler 118 via a line 134.

### The Coefficient Control Unit

In the coefficient control unit 114 the node 12.03 performs a vernier function. VentureForth® code here provides a free-running counter with a raw sigma count that is initially set to zero. In response to a changing transition on the aperture signal on line 132, node 12.03 increments the sigma count each time there is a raising transition in the clock signal on line 124. When the aperture signal transitions back, node 12.03 communicates the accumulated sigma count downstream to node 12.02, resets the sigma count back to zero, and waits for the aperture signal to again transition to repeat this cycle (potentially endlessly).

In the coefficient control unit 114 the node 12.02 performs a nomograph function. Here the raw sigma count received from node 12.03 is converted into a phase angle offset, based on values that have been pre-calculated and stored in the RAM 34 in node 12.02. Then node 12.02 communicates the phase angle offset to node 12.01.

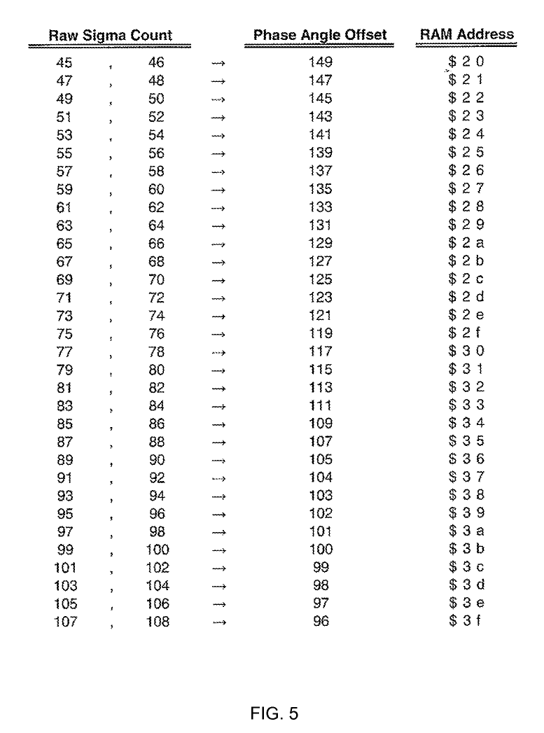

While it is possible for any raw sigma count value to be produced in node 12.03, in practice only values ranging from 45 to 108 inclusive are expected. The VentureForth® code here in node 12.02 therefore uses this to perform a subjective mapping of the potential 64 raw sigma counts to 32 different possible phase angle offsets (96 to 149 inclusive). Two consecutive sigma counts are mapped to a same phase angle offset, beginning with sigma counts 45 and 46 being mapped to phase angle offset 149, then sigma counts 47 and 48 are mapped to phase angle offset 147, and so forth. FIG. 5 is a table showing the mappings of all of the expected raw sigma counts against the phase angle offsets, as well as where the phase angle offsets are stored in the RAM 34 in node 12.02.

Digressing briefly, coincidental with the above, a number of other things are accomplished here in node 12.02. For both the aperture and clock signals, settling noise is removed and low-pass functions are performed to remove clock jitter. Additionally, since buffer overruns are not detected in a S/PDIF decoder (like that which may be feeding the audio signal into line 122 here), such overruns are made stable in node 12.02 so that bad samples do not enter the re-sampler 118.

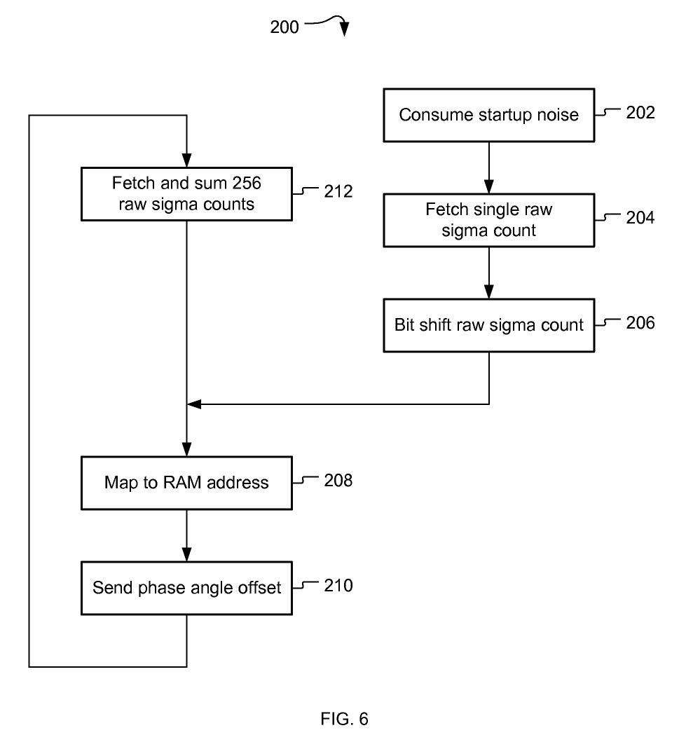

FIG. 6 is a flow chart showing a process 200 in which a non-linear function with the raw sigma count as an argument is used to look up the phase angle offsets stored in the RAM 34 in node 12.02. In a step 202, any startup noise is consumed and in a step 204, the first raw sigma count is received from node 12.03.

Then in a step 206, the first raw sigma count is bit shifted in the direction of its most significant bit eight times, effectively treating this like the fetching and summing of 257 counts. In a step 208, the value left on the top of the data stack after step 206 (which will be between $20 and $3f) is used as a memory address to access the RAM 34 and retrieve a corresponding phase angle offset. In a step 210, this phase angle offset is then passed on to node 12.01.

Next, still in node 12.02, in a step 212 the next 256 raw sigma counts from node 12.03 are fetched and summed. By using 256 counts, any jitter in the phase drift measurement is smoothed out. Then back again in step 208, the value left on the top of the data stack (which will again be between $20 and $3f) is used as a memory address to access the RAM 34 and retrieve a corresponding phase angle offset, and then again in step 210 this phase angle offset (a polyphase offset) is passed on to node 12.01.

In the coefficient control unit 114, the node 12.01 performs a rotor function. Here a new polyphase offset (p) is selected for down stream node 12.00. This polyphase offset (p) is the sum of the previous polyphase offset (p′) (the most recent polyphase offset sent to node 12.00) and the incoming phase angle offset (h) received from node 12.02. As a secondary objective, node 12.01 also determines if an angular wrap is produced by the polyphase offset computation. Angular wrap occurs when the equality (h+p′) mod 147=(h+p′) does not hold true. Notice here that if the sum of h and p′ are less than or equal to 146, this equality will hold true. For all other sums greater than 146, however, an angular wrap is deemed to have occurred.

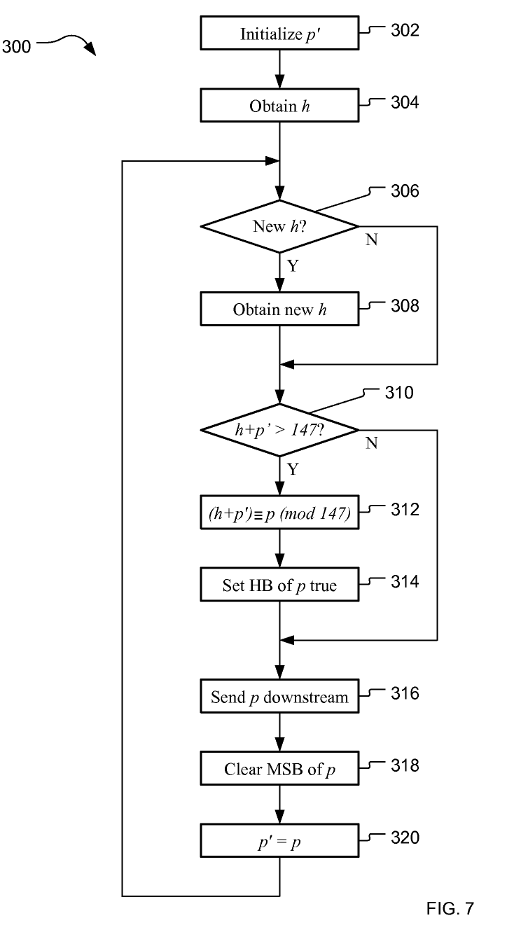

FIG. 7 is a flow chart showing a process 300 in which a new polyphase offset (p) is obtained. In a step 302, the polyphase offset (p′) is initialized to zero; and in a step 304 the new phase angle offset (h) is obtained from upstream node 12.02.

In a step 306, it is determined if there is a new phase angle offset (h) available from node 12.02. If so, a step 308 follows where the new phase angle offset (h) is used to replace the old value.

Next, or alternately if step 308 did not follow, in a step 310 it is determined if the sum of the phase angle offset (h) and the previous polyphase offset (p′) is greater than 146. If so, steps 312-314 follow. In step 312, the modular arithmetic operation of (p+p′)≡p (mod 147) is performed because an angular wrap has occurred. And in step 314, the most significant bit (MSB) of the register containing the result of step 312 is set to true.

Next, or alternately if steps 312-314 did not follow, in a step 316 the polyphase offset (p′) is provided to node 12.00 as it now stands. That is, if the sum of the phase angle offset (h) and the previous polyphase offset (p′) was less than or equal to 146, an angular wrap has not occurred and the value in step 308 is used. Otherwise, an angular wrap has occurred and the value in step 314 is used.

And in a step 318, the MSB of the polyphase offset (p′) is cleared, in a step 320, the polyphase offset (p′) is set equal to the polyphase offset (p), and the process 300 returns to step 306.

### The Memory/Coefficient Server

With reference again to FIG. 4, this also shows the inputs and outputs to the memory/coefficient server 116. A line 136 here is an input that carries in the polyphase offset (p) from node 12.01 (in the coefficient control unit 114). The line 128 is both an output to and an input from the external memory 126. The external memory 126 contains sets of 32 coefficients for each of the 147 possible polyphase offsets. A total of 4704 coefficients are thus stored here and one thing that node 12.01 does is retrieve sets of these coefficients that correspond with the respective polyphase offsets. A line 138 here is also an output, to node 12.06 in the re-sampler 118. The outputs from node 12.00 on line 138 are either coefficients retrieved from the external memory 126 or the value $20000.

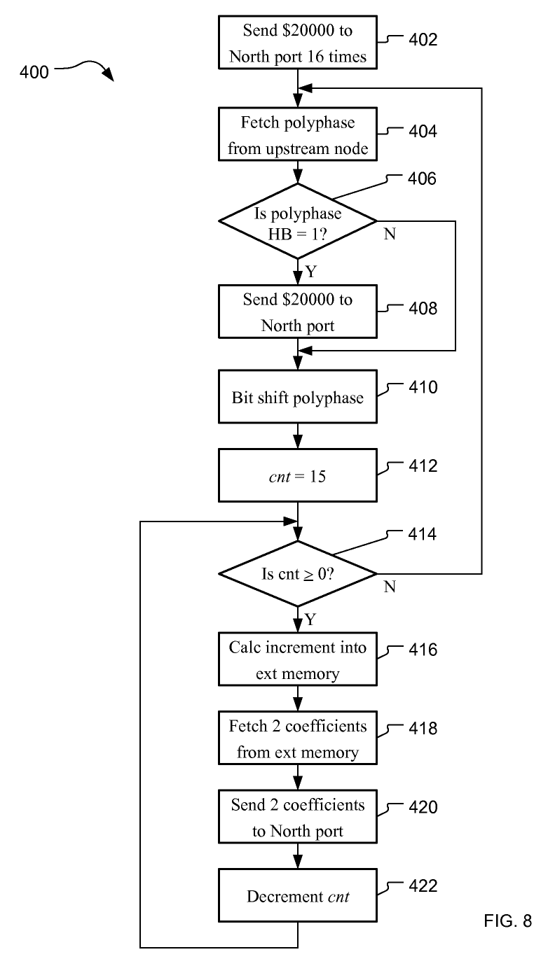

FIG. 8 is a flow chart showing a process 400 in which a set of coefficients for a given polyphase offset (p′) is obtained. In a step 402 the value $20000 is sent to node 12.06 sixteen consecutive times. This fills a 32-word FIR buffer in nodes 12.06, 12.08, 12.12, and 12.14 sequentially with 16 samples of the left and right audio values from node 12.19. Note that any time the value of $20000 is passed from node 12.00 to node 12.06, the effect is a rollup of this FIR buffer in nodes 12.06, 12.08, 12.12, and 12.14.

In a step 404, a polyphase offset (p′) is received from the upstream node, node 12.01.

In a step 406, it is determined if the MSB in the register containing the polyphase offset (p′) is true, that is, whether an angular wrap has occurred in the rotor (node 12.01). If so, step 408 follows. In step 408, the value of $20000 is sent to node 12.06.

Next, or alternately if step 408 did not follow, in a step 410 the polyphase offset (p′) is bit shifted toward the most significant bit (MSB) five times, and in each case the least significant bit (LSB) of the register containing it is zero filled.

In a step 412, a count (cnt) is initialized to 15. This count is used for two purposes. It defines the number of iterations in which a sequence of events is executed and it is used to calculate an increment into the external memory 126 to select two of the coefficients stored there.

In a step 414, it is determined if the count (cnt) is greater than or equal to zero. If so, steps 416-422 follow. [And otherwise step 404 is returned to.]In step 416, an increment into the external memory 126 is calculated based on the count (cnt) and the polyphase offset (p); in step 418, two coefficients are fetched from the external memory 126; in step 420 the two coefficients are sent to node 12.06; in step 422 the count (cnt) is decremented by one; and then step 414 is returned to. In this manner, for each polyphase offset (p′) received from node 12.01, a total of 32 coefficients are fetched from the external memory 126 by node 12.00 and passed to node 12.06.

### The Re-Sampler

Digressing briefly and with reference again to FIG. 4, it should be recalled that the L/R transfer unit 112 is made up of only node 12.18, and that its role is simply to pass the two values it receives from the decoder 110 on to node 12.12 of the re-sampler 118 via line 134.

Other than being implemented here in multiple nodes 12, the re-sampler 118 is generally conventional in concept and performs a conventional FIR filter function. The re-sampler 118 is therefore not discussed here in exhaustive detail.

FIG. 4 also shows the inputs and outputs to the re-sampler 118. The re-sampler 118 receives inputs from node 12.18 and node 12.00, as described above. The inputs from node 12.18 are the L/R decomposed audio sample values from the L/R transfer unit 112. And the inputs from node 12.00 are either the value $20000 or coefficient values retrieved from the external memory 126. Thus, node 12.12 receives the L/R values from node 12.18, passes the left values on to node 12.06 via a line 140, and passes the right values on to node 12.13. Node 12.06 receives the value $20000 or coefficients from node 12.00, replicates these to node 12.12 via line 140, and passes these on to node 12.07. Note, the value of $20000 is always processed in the re-sampler 118 as a rollup of the FIR buffer in nodes 12.06, 12.08, 12.12, and 12.14.

The left audio channel is re-sampled in nodes 12.06, 12.07, 12.08, and 12.09, while the right audio channel is re-sampled in nodes 12.12, 12.13, 12.14, and 12.15. During re-sampling, the 32 coefficients for each polyphase offset that have been fetched from the external memory 126 are used in the following manner.

As the coefficients are fetched (as single words in a vector of 32) from the external memory 126 (step 418), they are treated as interleaved A and B pairs, wherein the first, third, fifth, etc. are designated as “A-coefficients” and the second fourth, sixth, etc. are designated as “B-coefficients.” As each A-coefficient arrives in node 12.06, it is replicated and sent to node 12.12, where it will be passed onward to node 12.13. And as each B-coefficient arrives in node 12.06, it is similarly replicated to node 12.07 and passed onward to node 12.12. Both node 12.07 and node 12.13 are used as multiply accumulate nodes (MAC's) and therefore do not use the coefficients, instead simply passing them on to node 12.08 and node 12.14, respectively, where they are processed. [Note, this is in contrast to the L/R samples, which are read as a pair, the first of which is directed through node 12.06 to node 12.07, the second of which is directed through node 12.12 to node 12.13.]

### Summarizing Remarks

The circumstances in which the above described embodiment of the rate conversion device 100 will not work are self imposed, based on the problem the inventor was trying to solve. This embodiment has been developed with the need for performing rate conversion from 32 kHz, 44.1 kHz, and 48 kHz to 48 kHz. The limitation in this here is that the rate conversion can only be performed for those described frequencies. However, based on the principles disclosed above, those skilled in the art will now appreciate that other embodiments can be easily made to accommodate essentially any desired rate conversions. Doing this will merely require a few simple changes, such as the use of new polyphase tables and additionally, a few changes to the rotor and vernier. Ultimately, embodiments of the inventive rate conversion device 100 can be made for interpolating from any frequency as a starting point to any desired frequency as an ending point, and thus result in a general rate converter.

The inventive rate conversion device 100 employs a polyphase fractional delay low pass filter with a unique control structure for performing the needed calculations in an array 10 of nodes 12. A single stream of control information is used which conveys both the fact that a sample has to be accepted into the buffer in the re-sampler, as well as encapsulating the convolution curve which will be applied to it there.

Performing polyphase FIR filters is well known, but doing this on an array of processors in the manner disclosed here is not. For example, simply extending a polyphase FIR filter process that runs on one processor to instead run on two processors does not half the time required or result in each processor performing only half as much work. Time is additionally required and extra work is additionally required to integrate the work and the results. For present purposes we can term this an “integration overhead.”

The rate conversion device 100 avoids this by dedicating individual nodes and blocks of nodes to sub-tasks so that those sub-tasks are performed efficiently, which we can term a “specialization benefit.” In the rate conversion device 100 the sub-results of one block can be readily used by another connected block, which provides an additional benefit.

In addition, with suitable hardware the inventive rate conversion device 100 can also provide other benefits. The SEAforth® 24a device by IntellaSys® Corporation used in the exemplary embodiment described herein especially facilitates this. This device is noteworthy in that the nodes in it operate and communicate asynchronously. Asynchronous operation (clock-less operation) means that cycles are not wasted and that energy consumption is in relation to the work actually performed. Asynchronous communications means that the burden of synchronizing communications is essentially gone.

While various embodiments have been described above, it should be understood that they have been presented by way of example only, and that the breadth and scope of the invention should not be limited by any of the above described exemplary embodiments, but should instead be defined only in accordance with the following claims and their equivalents.

What is claimed is:

1. An apparatus for converting a source signal at a first sampling rate to a re-sampled signal at a second sampling rate, comprising:
an array of processors in which a decoder comprises a plurality of said processors, a transfer unit comprises at least one said processor, a coefficient control unit comprises a plurality of said processors, a coefficient server comprises at least one said processor, and a re-sampler comprises a plurality of said processors;
wherein,
said decoder decomposes said source signal into left source values and right source values and said decoder sends an aperture signal to said coefficient control unit upon decomposition completion;
said transfer unit controllably receives and passes said left source values and said right source values on to said re-sampler;
said coefficient control unit calculates a polyphase offset based on said aperture signal and a clock signal;
said coefficient server selectively passes coefficients to said re-sampler based on said polyphase offset; and
said re-sampler generates the re-sampled signal based on said left source values, said right source values, and said coefficients.

2. The apparatus of claim 1, wherein:
said array of processors are embodied in a single semiconductor die.

3. The apparatus of claim 1, wherein:
said coefficient control unit performs vernier, nomograph, and rotor functions to calculate said polyphase offset.

4. The apparatus of claim 1, wherein:
said coefficient server retrieves pre-calculated instances of said coefficients from a memory in which said coefficients have been pre-stored.

5. The apparatus of claim 4, wherein:
said memory is external to said array of processors.

6. The apparatus of claim 1, wherein:
said re-sampler generates the re-sampled signal as left and right re-sampled components.

7. The apparatus of claim 1, wherein:
said re-sampler generates the re-sampled signal with a fractional polyphase finite impulse response (FIR) filter.

8. The apparatus of claim 1, wherein:
the first sampling rate is 32 kHz, 44.1 kHz, or 48 kHz and the second sampling is 48 kHz.

9. A method for converting a source signal at a first sampling rate to a re-sampled signal at a second sampling rate with an array of processors, comprising:
decomposing said source signal in a plurality of the processors into left source values and right source values;
providing an aperture signal upon completion of said decomposing;
calculating a polyphase offset in a plurality of the processors based on said aperture signal and a clock signal;
providing coefficients based on said polyphase offset; and
generating the re-sampled signal in a plurality of the processors based on said left source values, said right source values, and said coefficients.

10. The method of claim 9, wherein:
the array of processors are embodied in a single semiconductor die.

11. The method of claim 9, wherein:
said calculating includes performing vernier, nomograph, and rotor functions to calculate said polyphase offset.

12. The method of claim 9, wherein:
said providing said coefficients includes retrieving pre-calculated instances of said coefficients from a memory in which said coefficients have been pre-stored.

13. The method of claim 12, wherein:
a set of 32 of said pre-calculated instances of said coefficients are retrieved.

14. The method of claim 9, wherein:
said generating provides the re-sampled signal as left and right re-sampled components.

15. The method of claim 9, wherein:
said generating includes re-sampling with a fractional polyphase finite impulse response (FIR) filter.

16. The method of claim 9, wherein:
the first sampling rate is 32 kHz, 44.1 kHz, or 48 kHz and the second sampling is 48 kHz.
